(19) United States
(12) Patent Application Publication
(10) Pub. No.: US 2025/0196968 A1
(43) Pub. Date: Jun. 19, 2025

(54) Torque Control Links for Snowmobiles

(71) Applicant: Arctic Cat Inc., Thief River Falls, MN (US)

(72) Inventors: Marcus Moldaschel, Thief River Falls, MN (US); David L. Vigen, Thief River Falls, MN (US); Benjamin Taylor Langaas, Thief River Falls, MN (US)

(73) Assignee: Arctic Cat Inc., Thief River Falls, MN (US)

(21) Appl. No.: 18/946,190

(22) Filed: Nov. 13, 2024

Related U.S. Application Data
(60) Provisional application No. 63/612,191, filed on Dec. 19, 2023.

(51) Int. Cl. B62M 27/02; F16H 57/025

(52) U.S. Cl. CPC B62M 27/02; F16H 57/025; B62M 2027/023

(57) ABSTRACT

A torque control link for maintaining a stable center to center distance between a primary clutch and a secondary clutch of a continuously variable transmission of a snowmobile. The torque control link includes a root section, a tip section and a main body that extends between the root section and the tip section. The root section has a plurality of engine mounting features that couple to the engine and a crankshaft aperture that receives the crankshaft therethrough with a clearance therebetween. The tip section has at least one chassis mounting feature that couples to the chassis and a jackshaft aperture that rotatably supports a jackshaft therein via a bearing. The main body has a waveform cross section with a substantially uniform thickness that not only improves the manufacturability of torque control link but also improves the strength of torque control link.

### CROSS-REFERENCE TO RELATED APPLICATIONS

The present application claims the benefit of United States Provisional Application No. 63/612, 191, filed Dec. 19, 2023 the entire contents of which is incorporated by reference herein for all purposes.

### TECHNICAL FIELD OF THE DISCLOSURE

The present disclosure relates, in general, to continuously variable transmissions for snowmobiles and, in particular, to torque control links having a main body with a waveform cross section that are used to maintain a stable center to center distance between the primary clutch and the secondary clutch of a continuously variable transmission on snowmobiles.

### BACKGROUND

Snowmobiles are popular land vehicles used for transportation and recreation in cold and snowy conditions. Certain snowmobiles are designed for specific applications such as trail, utility, mountain, race and crossover, to name a few. Snowmobiles typically include a chassis that supports various components of the snowmobile such as an engine, a transmission and a ground-engaging endless drive track disposed in a longitudinally extending drive tunnel. The engine and transmission power the drive track to enable ground propulsion for the vehicle. A rider controls the operation of the snowmobile using a steering system including a handlebar assembly that is operatively linked to a pair ski assemblies that provides flotation for the front of the snowmobile over the snow.

Some snowmobiles utilize a continuously variable transmission that is operable to adjust the gear ratio between the engine and the drive track through a continuous range by simultaneously varying the diameters of a primary clutch and a secondary clutch that are operably coupled together by a drive belt. To provide proper operations of the continuously variable transmission and to increase the longevity of components within the continuously variable transmission, it is essential to maintain a stable center to center distance between the primary clutch and the secondary clutch. It has been found, however, that engine movements caused by engine thrusts and/or engine vibrations tend to alter this center to center distance. Accordingly, a need has arisen for improved systems for maintaining a stable center to center distance between the primary clutch and the secondary clutch of a continuously variable transmission on snowmobiles.

### SUMMARY

In a first aspect, the present disclosure is directed to a torque control link for a continuously variable transmission of a snowmobile. The torque control link includes a root section, a tip section and a main body that extends between the root section and the tip section. The root section has a plurality of engine mounting features and a crankshaft aperture. The tip section has at least one chassis mounting feature and a jackshaft aperture. The main body has a waveform cross section with a substantially uniform thickness.

In certain embodiments, the root section, the main body and the tip section may be integrally formed as a single piece from a polymer composite material. In such embodiments, the polymer composite material may include reinforcement fibers. Also, in such embodiments, the reinforcement fibers in the main body may be substantially aligned in a longitudinal direction of the torque control link. In some embodiments, the root section, the main body and the tip section may be integrally formed as a single injection molded piece. In certain embodiments, the engine mounting features may be overmolded metal inserts. In some embodiments, the engine mounting features may be circumferentially distributed around the crankshaft aperture. In certain embodiments, the crankshaft aperture may be configured to receive a crankshaft therethrough with a clearance therebetween. In some embodiments, a damping component may be positioned at least partially within the at least one chassis mounting feature. In certain embodiments, a bearing may be positioned at least partially within the jackshaft aperture.

In some embodiments, the waveform cross section of the main body may be a sinusoidal waveform cross section. In certain embodiments, a wavelength of the waveform cross section may progressively increase at decreasing stations of the main body. In some embodiments, an amplitude of the waveform cross section may remain substantially constant at each station of the main body. In certain embodiments, the thickness of the waveform cross section may remain substantially constant at each station of the main body. In some embodiments, the main body may include a border at which first and second ends of the waveform cross section terminate. In such embodiments, the thickness of the waveform cross section and the thickness of the border may be substantially congruent. In certain embodiments, the waveform cross section may intersect the border at central locations of the border. In some embodiments, the width of the border may be substantially congruent with two times the amplitude of the waveform cross section.

In a second aspect, the present disclosure is directed to a powertrain for a snowmobile. The powertrain includes an engine having a crankshaft. A continuously variable transmission has a primary clutch, a secondary clutch and a drive belt configured to transfer torque from the primary clutch to the secondary clutch. The primary clutch is coupled to the crankshaft and is configured to receive torque from the engine via the crankshaft. The powertrain also includes a drive assembly and a jackshaft that is coupled between the secondary clutch and the drive assembly and is configured to transfer torque from the secondary clutch to the drive assembly. The powertrain further includes a track drive sprocket and a track driveshaft that is coupled between the drive assembly and the track drive sprocket and is configured to transfer torque from the drive assembly to the track drive sprocket. A torque control link includes a root section, a tip section and a main body that extends between the root section and the tip section. The root section has a plurality of engine mounting features and a crankshaft aperture. The tip section has at least one chassis mounting feature and a jackshaft aperture. The main body has a waveform cross section with a substantially uniform thickness. The torque control link is coupled to the engine via the engine mounting features such that the crankshaft extends through the crankshaft aperture. The jackshaft is rotatably coupled to the jackshaft aperture such that the torque control link maintains a stable center to center distance between the primary clutch and the secondary clutch.

In a third aspect, the present disclosure is directed to a snowmobile that includes an engine having a crankshaft. A continuously variable transmission has a primary clutch, a secondary clutch and a drive belt configured to transfer torque from the primary clutch to the secondary clutch. The primary clutch is coupled to the crankshaft and is configured to receive torque from the engine via the crankshaft. The snowmobile also includes a drive assembly and a jackshaft that is coupled between the secondary clutch and the drive assembly and is configured to transfer torque from the secondary clutch to the drive assembly. The snowmobile further includes a track drive sprocket and a track driveshaft that is coupled between the drive assembly and the track drive sprocket and is configured to transfer torque from the drive assembly to the track drive sprocket. An endless track is configured to receive torque from the track drive sprocket to propel snowmobile. A torque control link includes a root section, a tip section and a main body that extends between the root section and the tip section. The root section has a plurality of engine mounting features and a crankshaft aperture. The tip section has at least one chassis mounting feature and a jackshaft aperture. The main body has a waveform cross section with a substantially uniform thickness. The torque control link is coupled to the engine via the engine mounting features such that the crankshaft extends through the crankshaft aperture. The jackshaft is rotatably coupled to the jackshaft aperture such that the torque control link maintains a stable center to center distance between the primary clutch and the secondary clutch.

### BRIEF DESCRIPTION OF THE DRAWINGS

For a more complete understanding of the features and advantages of the present disclosure, reference is now made to the detailed description along with the accompanying figures in which corresponding numerals in the different figures refer to corresponding parts and in which:

FIGS. 1A-1C are isometric and side views of a snowmobile having a continuously variable transmission with a torque control link in accordance with embodiments of the present disclosure;

FIGS. 2A-2C are side views of a forward portion of a snowmobile having a continuously variable transmission with a torque control link in accordance with embodiments of the present disclosure;

FIGS. 3A-3B are isometric views of a drivetrain for a snowmobile having a continuously variable transmission with a torque control link in accordance with embodiments of the present disclosure;

FIGS. 4A-4C are side views of a torque control link for a continuously variable transmission of a snowmobile in accordance with embodiments of the present disclosure; and

FIGS. 5A-5D are cross sectional views of a torque control link for a continuously variable transmission of a snowmobile in accordance with embodiments of the present disclosure.

### DETAILED DESCRIPTION

While the making and using of various embodiments of the present disclosure are discussed in detail below, it should be appreciated that the present disclosure provides many applicable inventive concepts, which can be embodied in a wide variety of specific contexts. The specific embodiments discussed herein are merely illustrative and do not delimit the scope of the present disclosure. In the interest of clarity, all features of an actual implementation may not be described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present disclosure, the devices, members, apparatuses, and the like described herein may be positioned in any desired orientation. Thus, the use of terms such as “above,” “below,” “upper,” “lower” or other like terms to describe a spatial relationship between various components or to describe the spatial orientation of aspects of such components should be understood to describe a relative relationship between the components or a spatial orientation of aspects of such components, respectively, as the devices described herein may be oriented in any desired direction. As used herein, the term “coupled” may include direct or indirect coupling by any means, including by mere contact or by moving and/or non-moving mechanical connections.

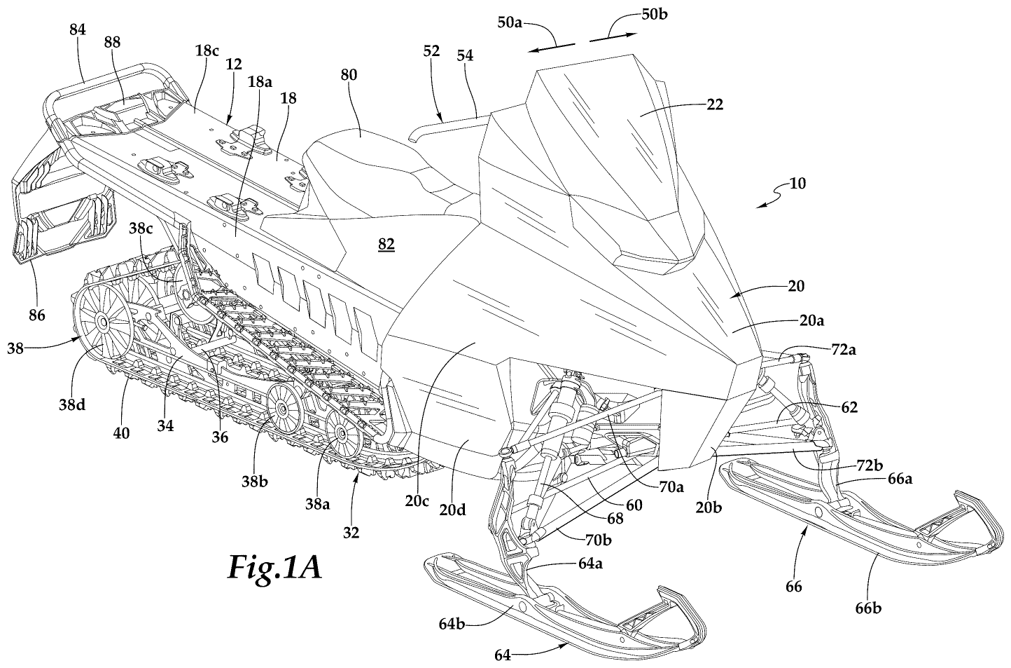

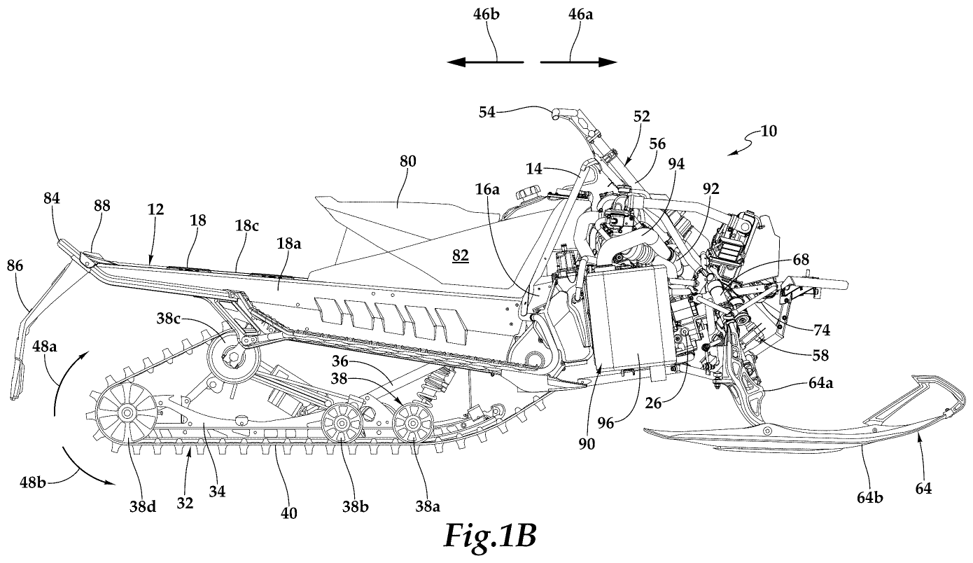

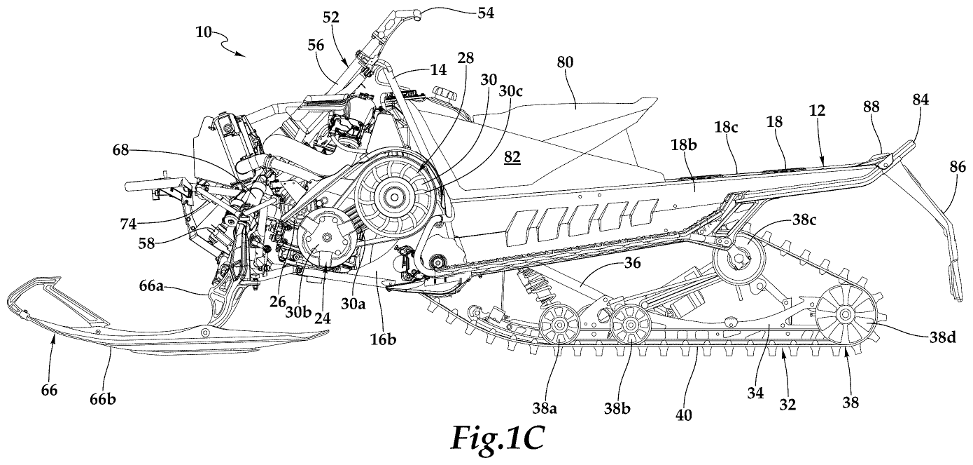

Referring to FIGS. 1A-1C in the drawings, a land vehicle depicted as a snowmobile is schematically illustrated and generally designated 10. Structural support for snowmobile 10 is provided by a chassis 12 that includes a forward frame assembly 14, a right side plate member 16a, a left side plate member 16b and a longitudinally extending drive tunnel 18. Forward frame assembly 14 is formed from interconnected tubular members such as round and hollow tubular members comprised of metal, metal alloy, polymeric materials, fiber reinforced polymer composites and/or combinations thereof that are coupled together by welds, bolts, pins or other suitable fastening means. Plate members 16a, 16b are coupled to and preferably welded to forward frame assembly 14 such that forward frame assembly 14 and plate members 16a, 16b form a welded frame assembly. Drive tunnel 18 is coupled to forward frame assembly 14 and/or plate members 16a, 16b with welds, bolts, rivets or other suitable means. In the illustrated embodiment, drive tunnel 18 includes a right side panel 18a, a left side panel 18b and a top panel 18c. Drive tunnel 18 may be integrally formed or may consist of multiple members that are coupled together with welds, bolts, rivets or other suitable means. Plate members 16a, 16b and drive tunnel 18 may be formed from sheet metal, metal alloy, fiber reinforced polymer or other suitable material or combination of materials.

Various components of snowmobile 10 are assembled on or around forward frame assembly 14. One or more body panels 20 cover and protect the various components of snowmobile 10 including parts of forward frame assembly 14. For example, a hood panel 20a, a nose panel 20b, an upper right side panel 20c and a lower right side panel 20d shield underlying componentry from the snow and terrain. Similarly, an upper left side panel and a lower left side panel (not visible) also shield underlying componentry from the snow and terrain. In the illustrated embodiment, snowmobile 10 has a windshield 22 that shields the rider of snowmobile 10 from snow, terrain and frigid air during operation. Even through snowmobile 10 has been described and depicted as including specific body panels 20, it should be understood by those having ordinary skill in the art that a snowmobile of the present disclosure may include any number of body panels in any configuration to provide the shielding functionality. In addition, it should be understood by those having ordinary skill in the art that the right side and the left side of snowmobile 10 will be with reference to a rider of snowmobile 10 with the right side of snowmobile 10 corresponding to the right side of the rider and the left side of snowmobile 10 corresponding to the left side of the rider.

Body panels 20 have been removed from snowmobile 10 in FIGS. 1B-1C to reveal the underlying components of snowmobile 10. For example, snowmobile 10 has a powertrain 24 that includes an engine 26 and a drivetrain 28 both of which are coupled to forward frame assembly 14. Engine 26 may be any type of engine such as a four-stroke engine, a two-stroke engine, an electric motor or other prime mover. In the illustrated embodiment, engine 26 is an internal combustion engine such as a naturally aspirated internal combustion engine, a supercharged internal combustion engine or a turbo charged internal combustion engine. Drivetrain 28 also includes a continuously variable transmission 30 that utilizes a torque control link 30a to maintain a stable center to center distance between a primary clutch 30b and a secondary clutch 30c. Continuously variable transmission 30 varies the ratio of the engine output speed to the drive track input speed.

A drive track system 32 is at least partially disposed within and/or below drive tunnel 18 and is in contact with the ground to provide ground propulsion for snowmobile 10. Torque and rotational energy are provided to drive track system 32 from powertrain 24. Drive track system 32 includes a track frame 34, an internal suspension 36, a plurality of idler wheels 38 such as idler wheels 38a, 38b, 38c, 38d and an endless track 40. Track frame 34 may be coupled to forward frame assembly 14 via a swing arm having a coil spring, a rigid strut, a torsion spring, an elastomeric member or any other suitable coupling configuration. Endless track 40 is driven by a track drive sprocket via a track driveshaft (not visible) that is rotated responsive to torque provided from continuously variable transmission 30. Endless track 40 rotates around track frame 34 and idler wheels 38 to propel snowmobile 10 in either the forward direction, as indicated by arrow 46a, or the backwards direction, as indicated by arrow 46b in FIG. 1B. When viewed from the right side of snowmobile 10, endless track 40 rotates around track frame 34 and idler wheels 38 in the clockwise direction, as indicated by arrow 48a, to propel snowmobile 10 in the forward direction 46a. Endless track 40 rotates around track frame 34 and idler wheels 38 in the counterclockwise direction, as indicated by arrow 48b, to propel snowmobile 10 in the backward direction 46b. The forward and backward directions also represent the longitudinal direction of snowmobile 10 with the lateral direction of snowmobile 10 being normal thereto and represented by the rightward direction, as indicated by arrow 50a, and the leftward direction, as indicated by arrow 50b in FIG. 1A. The backward direction may also be referred to herein as the aftward direction.

Snowmobile 10 has a steering system 52 that includes a handlebar assembly 54, a steering column 56, a steering arm assembly 58, a right tie rod 60, a left tie rod 62, a right ski assembly 64 including a right spindle 64a and a right ski 64b, and left ski assembly 66 including a left spindle 66a and a left ski 66b. Right ski assembly 64 and left ski assembly 66 may be referred to collectively as the ski system of snowmobile 10. Snowmobile 10 has a front suspension assembly 68 that is coupled between forward frame assembly 14 and ski assemblies 64, 66 to provide front end support for snowmobile 10. In addition, right ski assembly 64 is coupled to forward frame assembly 14 by upper and lower A-arms 70a, 70b, and left ski assembly 66 is coupled to forward frame assembly 14 by upper and lower A-arms 72a, 72b. Steering system 52 enables the rider to steer snowmobile 10 by rotating handlebar assembly 54 which causes ski assemblies 64, 66 to pivot. In the illustrated embodiment, the pivoting of ski assemblies 64, 66 responsive to rotation of handlebar assembly 54 is assisted by an electric power steering system (EPS) depicted as electronic steering assist unit 74.

The rider controls snowmobile 10 from a seat 80 that is position atop a fuel tank 82, above drive tunnel 18, aft of handlebar assembly 54 and aft of forward frame assembly 14. Snowmobile 10 has a lift bumper 84 that is coupled to an aft end of drive tunnel 18 that enables a person to lift the rear end of snowmobile 10 in the event snowmobile 10 becomes stuck or needs to be repositioned when it is not moving. Snowmobile 10 has a snow flap 86 that deflects snow emitted by endless track 40. A taillight housing 88 is also coupled to lift bumper 84 and houses a taillight of snowmobile 10. Snowmobile 10 has an exhaust system 90 that includes an exhaust manifold 92 that is coupled to one or more exhaust outlets on the forward side of engine 26, an exhaust duct 94 and a muffler 96.

It should be appreciated that snowmobile 10 is merely illustrative of a variety of vehicles that can implement the embodiments disclosed herein. Other vehicle implementations can include motorcycles, snow bikes, all-terrain vehicles (ATVs), utility vehicles, recreational vehicles, scooters, automobiles, mopeds, straddle-type vehicles and the like. As such, those skilled in the art will recognize that the embodiments disclosed herein can be integrated into a variety of vehicle configurations. It should be appreciated that even though ground-based vehicles are particularly well-suited to implement the embodiments of the present disclosure, airborne vehicles and devices such as aircraft can also implement the embodiments.

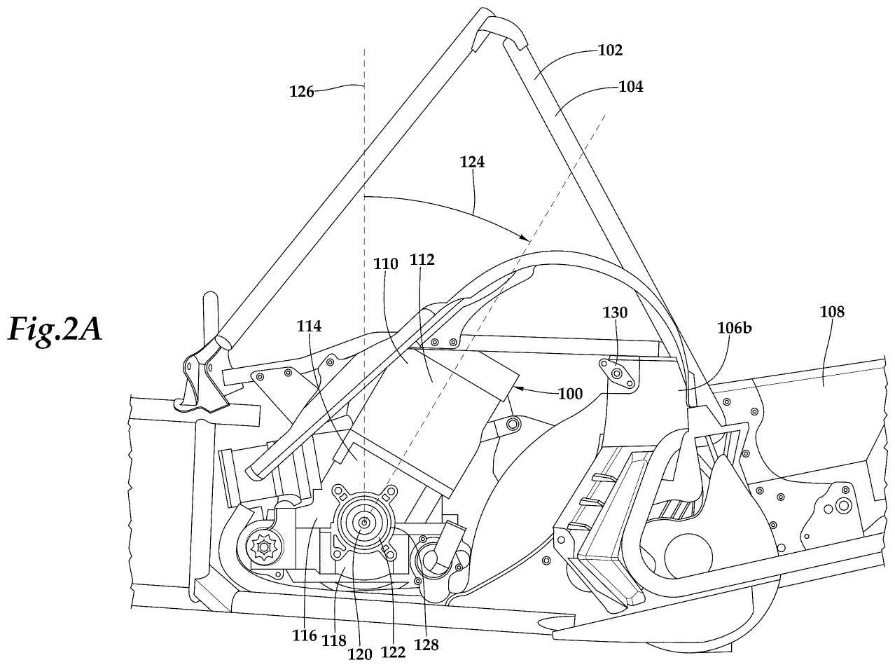

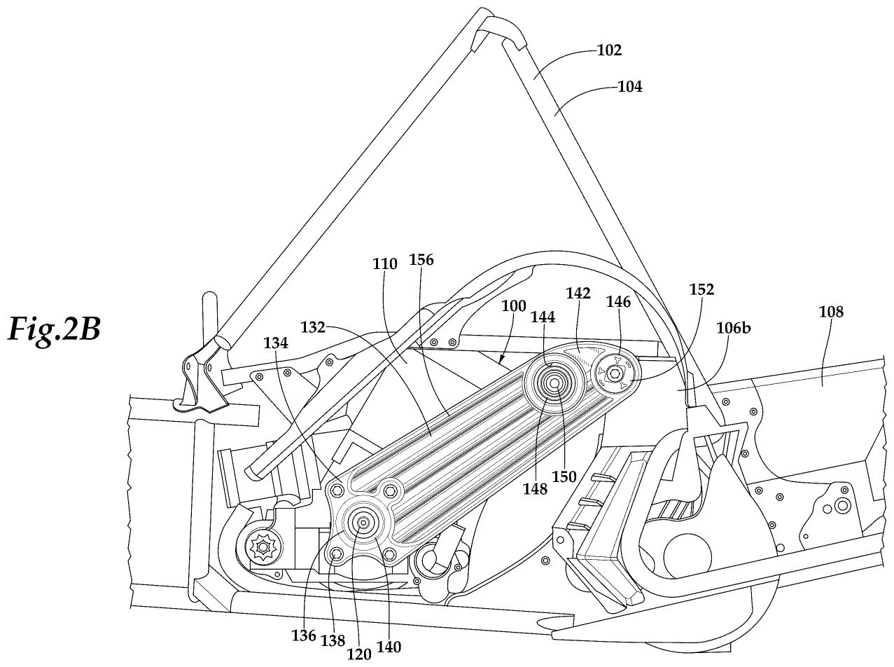

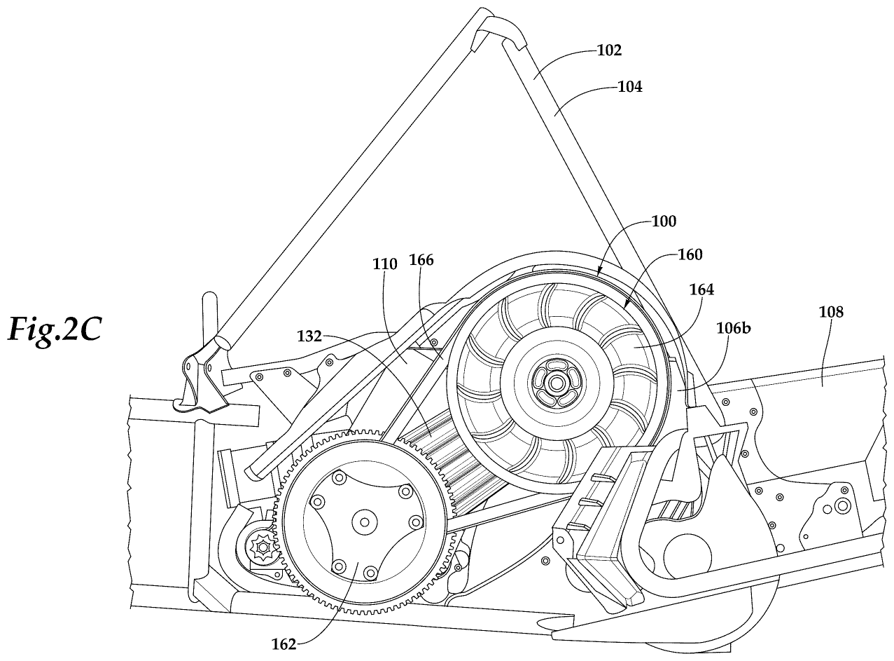

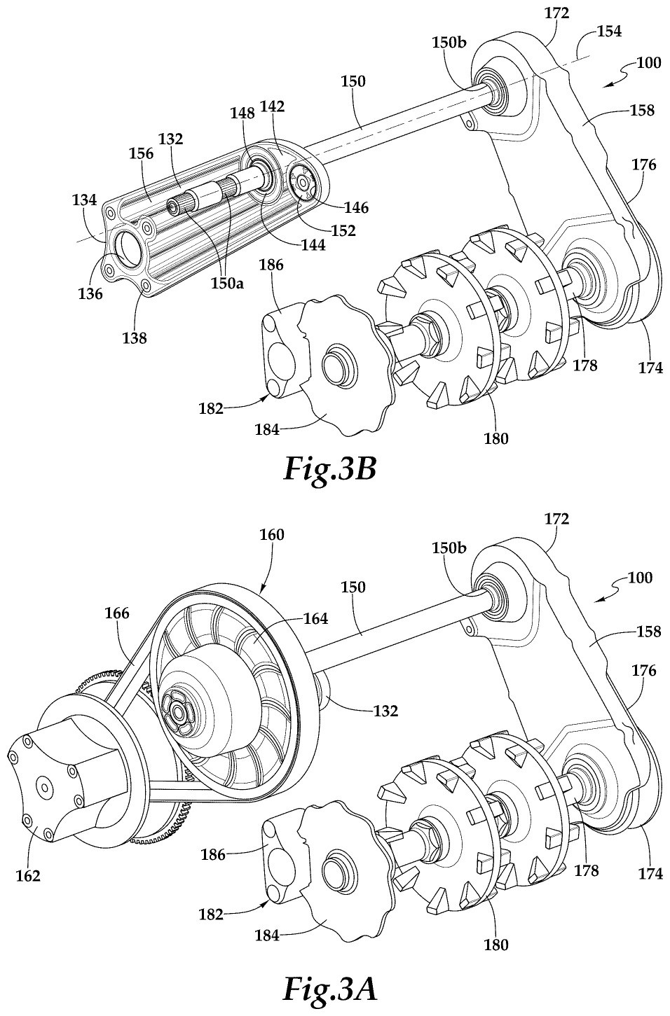

Referring to FIGS. 2A-2C and 3A-3B in the drawings, details regarding a powertrain 100, which is representative of powertrain 24 of snowmobile 10, will now be discussed. Powertrain 100 is supported by chassis 102 that includes a forward frame assembly 104, side panels 106a, 106b (only left side panel 106b being visible) and drive tunnel 108. As best seen in FIG. 2A, powertrain 100 include an internal combustion engine 110 that converts thermal energy into mechanical energy to drive the moving parts the snowmobile, thereby enabling motion. Engine 110 has a cylinder head 112 and an engine block 114 that includes a cylinder block 116 and a crankcase 118 which houses a crankshaft 120 supported by one or more bearings 122. In the illustrated embodiment, engine 110 has an aftward tilt angle 124 relative to a vertical plane 126 when the snowmobile is resting on a horizonal surface such as an aftward tilt angle between twenty-five degrees and thirty-five degrees or about thirty degrees. It should be understood by those having ordinary skill in the art that an engine of the present disclosure could have other aftward tilt angles less than twenty-five degrees or greater than thirty-five degrees relative to the vertical plane. In the illustrated embodiment, engine 110 includes a mounting flange 128 having four threaded receivers that are circumferentially distributed about crankshaft 120 at approximately ninety degree intervals and that may be integrally formed as a feature of engine block 114. Left side panel 106b of chassis 102 includes a mounting flange 130 having a centrally located threaded receiver.

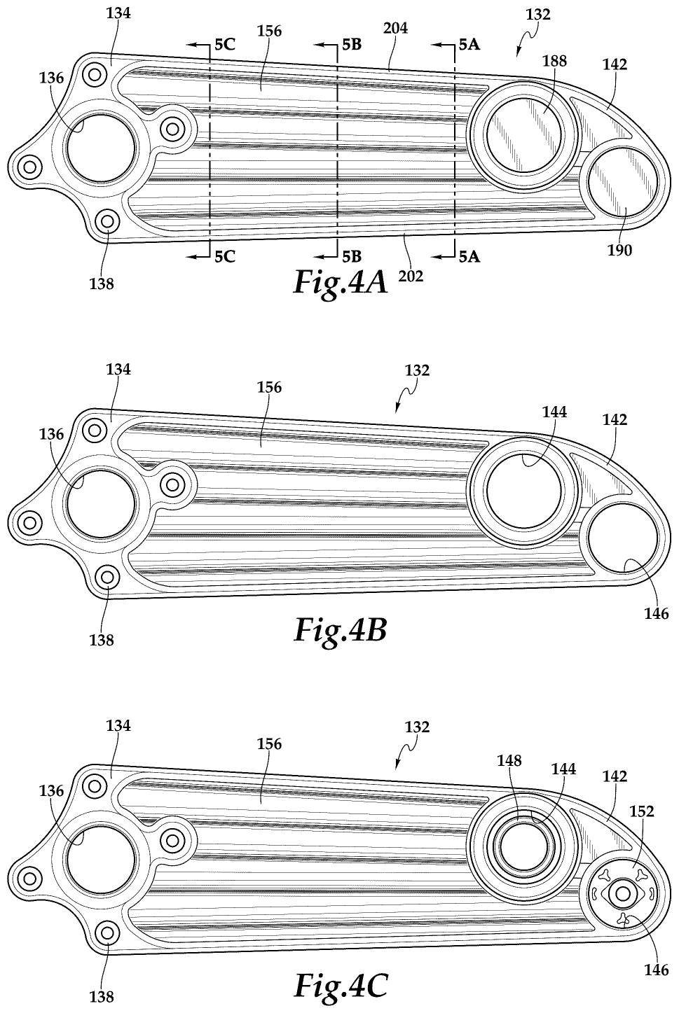

As best seen in FIG. 2B, a torque control link 132 has been installed on the snowmobile. In the illustrated embodiments, torque control link 132 has a root end 134 (see also FIG. 4C) that includes a crankshaft aperture 136 and a plurality of engine mounting features 138 that are circumferentially distributed around crankshaft aperture 136 at approximately ninety degree intervals. Even though engine mounting features 138 have been depicted and described as being circumferentially distributed around crankshaft aperture 136 at substantially uniform intervals, it should be understood by those having ordinary skill in the art that the engine mounting features of a torque control link could have other orientations relative to a crankshaft aperture including non-uniform circumferential distributions or non-circumferential distributions so long as the engine mounting features properly align with the threaded receivers of the mounting flange of the engine. In the illustrated embodiment, torque control link 132 is secured to engine 110 using fasteners depicted as four bolts that extend through engine mounting features 138 and are threadably coupled to the aligned threaded receivers of mounting flange 128. In this secure configuration, crankshaft 120 extends through crankshaft aperture 136 with a clearance 140 therebetween such that torque control link 132 does not interfere with the rotation of crankshaft 120 during operations.

Torque control link 132 has a tip section 142 that includes a jackshaft aperture 144 and at least one chassis mounting feature 146. Jackshaft aperture 144 is configured to receive and support a bearing assembly 148, such as a ball bearing assembly, through which a jackshaft 150 passes such that jackshaft 150 is rotatably coupled to torque control link 132 (see also FIG. 3B). Chassis mounting feature 146 is configured to receive and support a damping component 152, such as a rubber or polymeric insert having, for example, a shore A hardness between 40 and 80 or a shore A hardness of about 60. Damping component 152 reduces vibration and provides a mechanism to absorb movement and prevent stress on both chassis 102 and torque control link 132. In the illustrated embodiment, torque control link 132 is secured to chassis 102 using a fastener depicted as a bolt that extends through damping component 152 and is threadably coupled to the aligned threaded receiver of mounting flange 130. Torque control link 132 is thus secured to both engine 110 and chassis 102 and in this position, maintains a stable the center to center distance between the axis of rotation of crankshaft 120 and the axis of rotation 154 of jackshaft 150. Torque control link 132 has a main body 156 that extends between root section 134 and tip section 142. At each station of main body 156 between root section 134 and tip section 142, main body 156 has a waveform cross section with a substantially uniform thickness that not only improves the manufacturability of torque control link 132 but also improves the strength and stiffness of torque control link 132, as discussed herein.

As best seen in FIG. 2C, a continuously variable transmission 160 has been installed on the snowmobile. In the illustrated embodiment, continuously variable transmission 160 includes a primary clutch 162 that receives torque and rotational energy from engine 110 via crankshaft 120, a secondary clutch 164 that delivers torque and rotational energy to a drive assembly 158 via jackshaft 150 (see also FIG. 3A) and a drive belt 166 that is looped between primary clutch 162 and secondary clutch 164 to transfer torque from primary clutch 162 to secondary clutch 164. Continuously variable transmission 160 is configured to continuously change its gear ratio such that at any engine speed, continuously variable transmission 160 is configured to operate at peak performance. This is achieved by varying the width of primary clutch 162 and secondary clutch 164 depending on the power requirement of the snowmobile. In operation, when one of primary clutch 162 and secondary clutch 164 gets larger, the other of primary clutch 162 and secondary clutch 164 gets smaller. Since neither primary clutch 162, secondary clutch 164 nor drive belt 166 is fixed, continuously variable transmission 160 is configured to provide an infinite number of gear ratios. As torque control link 132 maintains a stable the center to center distance between the axis of rotation of crankshaft 120 and the axis of rotation 154 of jackshaft 150, torque control link 132 thus maintains a stable the center to center distance between primary clutch 162 and secondary clutch 164, which not only enables proper operations of continuously variable transmission 160 including consistent belt tensioning but also increases the longevity of the components within continuously variable transmission 160.

As best seen in FIGS. 3A-3B, secondary clutch 164 provides torque and rotational energy to jackshaft 150. In the illustrated embodiment, jackshaft 150 includes multiple splined sections including input splines 150a and output splines 150b. Input splines 150a are in mesh with splines within secondary clutch 164 such that operation of continuously variable transmission 160 rotates jackshaft 150. Output splines 150b are in mesh with splines within drive assembly 158 that is depicted as a reduction drive assembly. Drive assembly 158 includes a drive pulley 172 that receives torque and rotational energy from jackshaft 150, a driven pulley 174 and a drive belt 176 that is looped around drive pulley 172 and driven pulley 174 to transfer torque from drive pulley 172 to driven pulley 174. Driven pulley 174 provides torque and rotational energy to a track driveshaft 178 that has a splined coupling with track drive sprocket 180 that drives the endless track around the track frame and the idler wheels to propel the snowmobile. Track driveshaft 178 also has a splined coupling with a disc-and-caliper braking system 182 that includes a brake disc 184 and a brake caliper 186 used to provide a stopping force for the snowmobile. Jackshaft 150 is rotatably coupled to torque control link 132 via bearing assembly 148 which is received within jackshaft aperture 144. In this manner, torque control link 132, which is coupled to engine 110 and chassis 102, supports jackshaft 150 and allows jackshaft 150 to transfer torque and rotational energy from continuously variable transmission 160 to drive assembly 158.

Referring now to FIGS. 4A-4C, additional details regarding torque control link 132 will now be discussed. Torque control link 132 may be integrally formed as a single piece from a polymer composite material. For example, the polymer composite material may include Nylon 6/6, Polyetheretherketone (PEEK), Polypropylene (PP), Polyphthalamide (PPA) or other suitable polymer material with a reinforcement fiber such as a glass fiber, a carbon fiber or ratio of both glass fiber and carbon fiber distributed therein. In some embodiments, the reinforcement fiber may have a percent volume from 10 percent to 70 percent such as from 40 percent to 60 percent or from 45 percent to 55 percent. In certain embodiments, the reinforcement fiber may be a long-fiber on the order of 10 mm to 14 mm such as about 12 mm. In other embodiments, the reinforcement fiber may be shorter than 10 mm or longer than 14 mm. Torque control link 132 may be formed using an injection molding process wherein a molten polymer matrix is injected into a mold cavity at a gate located proximate the tip end of torque control link 132. In one example, the injection molding process begins by heating pellets of the desired blend of polymer resin and reinforcement fiber in a hopper until the material reaches a molten and/or viscous state. The molten polymer matrix then enters a screw mechanism that forces the molten polymer matrix through a nozzle and into the mold cavity under high pressure. The flow front of the molten polymer matrix travel through the mold from the tip end to the root end until the entire mold is filled. The molten polymer matrix is then allowed to cool which cause the material to solidify. As the material cools and solidifies, the reinforcement fibers become interwoven with the polymer, creating a polymer composite material with high strength, high stiffness and dimensional stability that can withstand mechanical stress. After solidification, the mold is open for removal of the injection molded piece. The injection molding process is a cost-effectiveness, high precision and highly repeatable process for making the torque control links of the present disclosure.

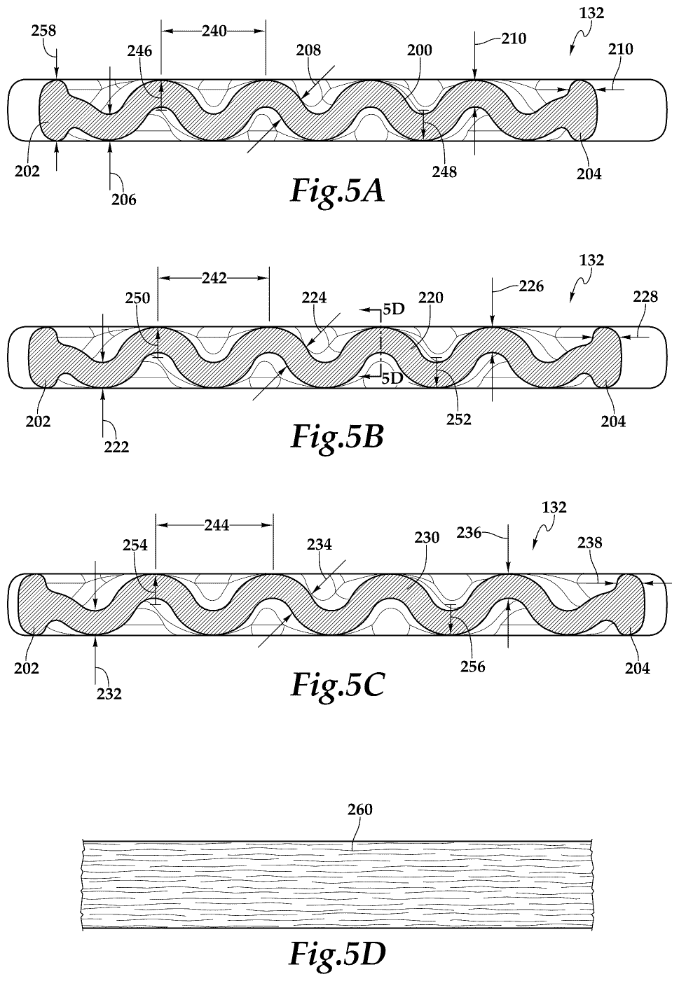

To obtain the desired strength and stiffness in the torque control links of the present disclosure, it is desirable to have the reinforcement fibers uniformly distributed and substantially aligned in the tip to root direction, which may also be referred to as the longitudinal direction, of the torque control link. This is achieved by designing the torque control links of the present disclosure to have a unique waveform cross section, such as a sinusoidal waveform cross section, with a substantially uniform thickness. FIGS. 5A-5C depict three cross sectional views of torque control link 132 respectively at a first station of main body 156 that is proximate tip section 142 and taken along line 5A-5A, a second station of main body 156 that is proximate the center of main body 156 and taken along line 5B-5B and a third station of main body 156 that is proximate root section 134 and taken along line 5C-5C. As seen in FIG. 5A, the cross section at the first station of main body 156, torque control link 132 has a waveform cross section 200 having a substantially uniform thickness along its entire length between its terminating ends at borders 202, 204. For example, in trough sections including the trough section indicated at 206, in ascending and descending sections including the descending section indicated at 208 and in peak sections including the peak section indicated at 210, the thickness of the waveform is substantially uniform. In addition, the thickness of borders 202, 204 as indicated at border section 210 is substantially congruent with the thickness of the waveform. This thickness also remains substantially uniform at the intersections of waveform cross section 200 with borders 202, 204 which occur at central locations of borders 202, 204 to form I-beam type end caps on waveform cross section 200 which enhance the bending stiffness of torque control link 132.

As seen in FIG. 5B, the cross section at the second station of main body 156, torque control link 132 has a waveform cross section 220 having a substantially uniform thickness along its entire length between its terminating ends at borders 202, 204. For example, in trough sections including the trough section indicated at 222, in ascending and descending sections including the descending section indicated at 224 and in peak sections including the peak section indicated at 226, the thickness of the waveform is substantially uniform. In addition, the thickness of borders 202, 204 as indicated at border section 228 is substantially congruent with the thickness of the waveform. This thickness also remains substantially uniform at the intersections of waveform cross section 220 with borders 202, 204 which occur at central locations of borders 202, 204 to form I-beam type end caps on waveform cross section 220 which enhance the bending stiffness of torque control link 132.

As seen in FIG. 5C, the cross section at the third station of main body 156, torque control link 132 has a waveform cross section 230 having a substantially uniform thickness along its entire length between its terminating ends at borders 202, 204. For example, in trough sections including the trough section indicated at 232, in ascending and descending sections including the descending section indicated at 234 and in peak sections including the peak section indicated at 236, the thickness of the waveform is substantially uniform. In addition, the thickness of borders 202, 204 as indicated at border section 238 is substantially congruent with the thickness of the waveform. This thickness also remains substantially uniform at the intersections of waveform cross section 230 with borders 202, 204 which occur at central locations of borders 202, 204 to form I-beam type end caps on waveform cross section 230 which enhance the bending stiffness of torque control link 132.

Not only does the thickness of each of waveform cross sections 210, 220, 230 remain substantially uniform along its entire length between its terminating ends at borders 202, 204, the thicknesses of waveform cross sections 210, 220, 230 are substantially congruent with each other. Stated more generally, the thickness of the waveforms remains substantially constant at each station of main body 156 of torque control link 132 between tip section 142 and root section 134. Even though three stations of main body 156 have been depicted and described, it should be understood by those having ordinary skill in the art that main body 156 could be sectioned at an infinite number of stations between tip section 142 and root section 134.

As best seen by comparing FIGS. 5A-5C, the length of torque control link 132 in the cross sectional direction progressively increases from tip section 142 to root section 134 including progressively increasing in main body 156 in the direction from tip section 142 to root section 134 which will be referred to herein as decreasing stations of main body 156. As illustrated, the length of waveform cross section 210 is less than the length of waveform cross section 220 which is less than the length of waveform cross section 230. Illustrated another way, a wavelength 240 of waveform cross section 210 is less than a wavelength 242 of waveform cross section 220 which is less than a wavelength 244 of waveform cross section 230. Stated more generally, the wavelength of the waveforms progressively increases at decreasing stations of main body 156. As best seen in FIGS. 5A-5C, the amplitude of each of waveform cross sections 210, 220, 230 remain substantially uniform along its entire length between its terminating ends at borders 202, 204. For example, the amplitude of waveform cross section 210 as indicated at locations 246, 248 is substantially uniform, the amplitude of waveform cross section 220 as indicated at locations 250, 252 is substantially uniform and the amplitude of waveform cross section 230 as indicated at locations 254, 256 is substantially uniform. As best seen by comparing FIGS. 5A-5C, the amplitudes of waveform cross sections 210, 220, 230 are substantially congruent with each other. Stated more generally, the amplitude of the waveforms remains substantially constant at each station of main body 156 of torque control link 132. It is noted that the width of borders 202, 204 is substantially congruent with two times the amplitude of the waveform cross sections. This is best seen by comparing width 258 of border 202 in FIG. 5A with the amplitude indicated at locations 246, 248.

The uniformity in the thickness along the length of each waveform and at each cross sectional station of main body 156 as well as the uniformity in the thickness of borders 202, 204 and the intersections of the waveforms with borders 202, 204 provide a path of substantially uniform thickness for the progressing molten polymer matrix flow front during the injection molding process which tends to improve the fiber alignment in the longitudinal direction within main body 156. As best seen in FIG. 5D, which is a cross sectional view taken along line 5D-5D of FIG. 5B, the depicted reinforcement fibers 260 are substantially aligned in the longitudinal direction within main body 156.

It should be noted that prior to the injection molding process, engine mounting features 138 are positioned within the mold cavity at the desired locations. During the injection molding process, engine mounting features 138 are overmolded such that upon solidification of the polymer composite material, engine mounting features 138 are secured within the polymer composite material and are considered to be integral with the polymer composite material. In the illustrated embodiment, engine mounting features 138 are metal inserts, such brass inserts, which have a greater resistance to compression than does the polymer composite material that forms the remainder of torque control link 132 which improves the integrity of the bolted connection between torque control link 132 and engine 110.

FIG. 4A represents torque control link 132 upon removal from a mold following the injection molding process. In this state, torque control link 132 includes excess polymer composite material in the locations that become jackshaft aperture 144 and chassis mounting feature 146. Specifically, excess polymer composite material 188 and excess polymer composite material 190 have dome shaped surfaces and/or may have non-uniform thicknesses to aid in controlling the directionality and velocity of the progressing molten polymer matrix flow front in the tip section such that the flow front will progress through main body 156 substantially normal to the longitudinal direction of main body 156. This substantially perpendicular flow front tends to improve the fiber alignment in the longitudinal direction within main body 156. Following the removal of torque control link 132 from the mold, excess polymer composite material 188 and excess polymer composite material 190 are removed from torque control link 132 to create jackshaft aperture 144 and chassis mounting feature 146, as best seen in FIG. 4B. Thereafter, bearing assembly 148 may be installed within jackshaft aperture 144 and damping component 152 may be installed within chassis mounting feature 146, as best seen in FIG. 4C.

The unique waveform cross sections with uniform thickness of torque control link 132 function to improve the manufacturability of torque control link 132 by enabling longitudinal fiber alignment which improves the strength, stiffness and structural integrity of torque control link 132. In addition, the unique waveform cross sections with uniform thickness also functions to improve the manufacturability by promoting uniform cooling which minimizes warping, internal stresses and uneven shrinkage. Further, the unique waveform cross sections with uniform thickness of torque control link 132 function to improve the utility of torque control link 132 by creating a series of offset beams that result in a component that has structural integrity, durability, a high strength, high stiffness and low weight.

The foregoing description of embodiments of the disclosure has been presented for purposes of illustration and description. It is not intended to be exhaustive or to limit the disclosure to the precise form disclosed, and modifications and variations are possible in light of the above teachings or may be acquired from practice of the disclosure. The embodiments were chosen and described in order to explain the principals of the disclosure and its practical application to enable one skilled in the art to utilize the disclosure in various embodiments and with various modifications as are suited to the particular use contemplated. For example, numerous combinations of the features disclosed herein will be apparent to persons skilled in the art including the combining of features described in different and diverse embodiments, implementations, contexts, applications and/or figures. Other substitutions, modifications, changes and omissions may be made in the design, operating conditions and arrangement of the embodiments without departing from the scope of the present disclosure. Such modifications and combinations of the illustrative embodiments as well as other embodiments will be apparent to persons skilled in the art upon reference to the description. It is, therefore, intended that the appended claims encompass any such modifications or embodiments.

What is claimed is:

1. A torque control link for a continuously variable transmission of a snowmobile, the torque control link comprising:
a root section having a plurality of engine mounting features and a crankshaft aperture;
a tip section having at least one chassis mounting feature and a jackshaft aperture; and
a main body extending between the root section and the tip section, the main body having a waveform cross section with a substantially uniform thickness.

2. The torque control link as recited in claim 1 wherein, the root section, the main body and the tip section are integrally formed as a single piece from a polymer composite material.

3. The torque control link as recited in claim 2 wherein, the polymer composite material includes reinforcement fibers.

4. The torque control link as recited in claim 3 wherein, the reinforcement fibers in the main body are substantially aligned in a longitudinal direction of the torque control link.

5. The torque control link as recited in claim 1 wherein, the root section, the main body and the tip section are integrally formed as a single injection molded piece.

6. The torque control link as recited in claim 1 wherein, the engine mounting features further comprise overmolded metal inserts.

7. The torque control link as recited in claim 1 wherein, the engine mounting features are circumferentially distributed around the crankshaft aperture.

8. The torque control link as recited in claim 1 wherein, the crankshaft aperture is configured to receive a crankshaft therethrough with a clearance therebetween.

9. The torque control link as recited in claim 1 further comprising a damping component positioned at least partially within the at least one chassis mounting feature.

10. The torque control link as recited in claim 1 further comprising a bearing positioned at least partially within the jackshaft aperture.

11. The torque control link as recited in claim 1 wherein, the waveform cross section of the main body is a sinusoidal waveform cross section.

12. The torque control link as recited in claim 1 wherein, a wavelength of the waveform cross section progressively increases at decreasing stations of the main body.

13. The torque control link as recited in claim 1 wherein, an amplitude of the waveform cross section remains substantially constant at each station of the main body.

14. The torque control link as recited in claim 1 wherein, the thickness of the waveform cross section remains substantially constant at each station of the main body.

15. The torque control link as recited in claim 1 wherein, the main body includes a border; and
wherein, first and second ends of the waveform cross section terminate at the border.

16. The torque control link as recited in claim 15 wherein, the thickness of the waveform cross section and the thickness of the border are substantially congruent.

17. The torque control link as recited in claim 15 wherein, the waveform cross section intersects the border at central locations of the border.

18. The torque control link as recited in claim 15 wherein, a width of the border is substantially congruent with two times the amplitude of the waveform cross section.

19. A powertrain for a snowmobile, the powertrain comprising:
an engine having a crankshaft;
a continuously variable transmission having a primary clutch, a secondary clutch and a drive belt configured to transfer torque from the primary clutch to the secondary clutch, the primary clutch coupled to the crankshaft and configured to receive torque from the engine via the crankshaft;
a drive assembly;
a jackshaft coupled between the secondary clutch and the drive assembly and configured to transfer torque from the secondary clutch to the drive assembly;
a track drive sprocket;
a track driveshaft coupled between the drive assembly and the track drive sprocket and configured to transfer torque from the drive assembly to the track drive sprocket; and
a torque control link including a root section having a plurality of engine mounting features and a crankshaft aperture, a tip section having at least one chassis mounting feature and a jackshaft aperture and a main body extending between the root section and the tip section, the main body having a waveform cross section with a substantially uniform thickness;
wherein, the torque control link is coupled to the engine via the engine mounting features such that the crankshaft extends through the crankshaft aperture; and
wherein, the jackshaft is rotatably coupled to the jackshaft aperture such that the torque control link maintains a stable center to center distance between the primary clutch and the secondary clutch.

20. A snowmobile comprising:
an engine having a crankshaft;
a continuously variable transmission having a primary clutch, a secondary clutch and a drive belt configured to transfer torque from the primary clutch to the secondary clutch, the primary clutch coupled to the crankshaft and configured to receive torque from the engine via the crankshaft;
a drive assembly;
a jackshaft coupled between the secondary clutch and the drive assembly and configured to transfer torque from the secondary clutch to the drive assembly;
a track drive sprocket;
a track driveshaft coupled between the drive assembly and the track drive sprocket and configured to transfer torque from the drive assembly to the track drive sprocket;
an endless track configured to receive torque from the track drive sprocket to propel snowmobile; and
a torque control link including a root section having a plurality of engine mounting features and a crankshaft aperture, a tip section having at least one chassis mounting feature and a jackshaft aperture and a main body extending between the root section and the tip section, the main body having a waveform cross section with a substantially uniform thickness;
wherein, the torque control link is coupled to the engine via the engine mounting features such that the crankshaft extends through the crankshaft aperture; and
wherein, the jackshaft is rotatably coupled to the jackshaft aperture such that the torque control link maintains a stable center to center distance between the primary clutch and the secondary clutch.
